(19) United States
(12) Patent Application Publication
(10) Pub. No.: US 2007/0070183 A1
(43) Pub. Date: Mar. 29, 2007

(54) Control apparatus and method

(76) Inventor: Barrie William Davis, O'Malley (AU)

Correspondence Address: VINSON & ELKINS, L.L.P., 1001 FANNIN STREET, 2300 FIRST CITY TOWER, HOUSTON, TX, 77002-6760, US

(21) Appl. No.: 11/529,136

(22) Filed: Sep. 28, 2006

(30) Foreign Application Priority Data
Oct. 14, 2005 (AU) 2005222552
Sep. 29, 2005 (AU) 2005905366

(51) Int. Cl. H04N 7/14

(52) U.S. Cl. 348/14.02

(57) ABSTRACT

A method of controlling an entertainment system and a communication system is disclosed, the entertainment system including at least one fixed audio and/or video output device and the communication system including a mobile telephone having storage means for storing audio and/or video data, the method including:- docking the mobile telephone in phone connector means in a docking assembly to establishing wired contact there between; establishing communication between audio and/or video connector means in the docking assembly and the entertainment system; establishing communication between respective radio transceivers in the docking assembly and in a remote controller, and inputting control signals via input control means in the remote controller to microprocessor control means; the microprocessor control means being operable in accordance with instructions from the input control means to allow the remote controller to operate as a quasi mobile telephone and to allow the entertainment system to process the audio and/or video data stored in the mobile telephone storage means.

### TECHNICAL FIELD

This invention relates to a control apparatus and method, and has particular but not exclusive application to an apparatus and method for controlling an entertainment and communication system. The invention has particular application to a home entertainment and telephone system and reference will be made herein to such an application by way of illustrative example.

### BACKGROUND OF INVENTION

Small portable digital audio players utilising audio compression algorithms, and semiconductor flash memory or relatively light portable hard drive players are known and can store thousands of music tracks. One example is the so-called iPod (iPod is a registered trade mark of Apple Computer Inc). Mobile phones incorporating semiconductor flash memory and support for digital audio playback are also known. Although not yet commercially available, mobile phones having a hard drive music player will be released shortly.

The present invention aims to provide an alternative to known apparatus and methods for controlling an entertainment system and a communication system, and which utilises such a mobile phone which is herein termed a Mobile Phone and Music Player (MPMP).

### SUMMARY OF INVENTION

This invention in one aspect resides broadly in an apparatus for controlling an entertainment system and a communication system, the entertainment system including at least one fixed audio and/or video output device and the communication system including a mobile telephone having storage means for storing audio and/or video data, the apparatus including:

a docking assembly including:
phone connector means for establishing wired contact with the mobile telephone,
audio and/or video connector means for establishing communication with the entertainment system, and
a radio transceiver for establishing communication with a remote controller;

a remote controller including:
a radio transceiver for establishing communication with the docking assembly,
an audio input and an audio output, and
input control means; and

microprocessor control means operable in accordance with instructions from the input control means to allow the remote controller to operate as a quasi mobile telephone and to allow the entertainment system to process the audio and/or video data stored in the mobile telephone storage means.

In another aspect this invention resides broadly in a method of controlling an entertainment system and a communication system, the entertainment system including at least one fixed audio and/or video output device and the communication system including a mobile telephone having storage means for storing audio and/or video data, the method including:

docking the mobile telephone in phone connector means in a docking assembly to establishing wired contact there between;

establishing communication between audio and/or video connector means in the docking assembly and the entertainment system;

establishing communication between respective radio transceivers in the docking assembly and in a remote controller, and

inputting control signals via input control means in the remote controller to microprocessor control means;

the microprocessor control means being operable in accordance with instructions from the input control means to allow the remote controller to operate as a quasi mobile telephone and to allow the entertainment system to process the audio and/or video data stored in the mobile telephone storage means.

It is preferred that the docking assembly includes battery charging means for recharging a mobile phone battery.

It is also preferred that the docking assembly and the remote controller each includes microprocessor control means.

In one embodiment the audio and/or video connector means establish wired communication with the entertainment system. Alternatively, the audio and/or video connector means can establish wireless communication with the entertainment system.

It is also preferred that the input control means is a keyboard or keypad. Suitably, the keyboard or keypad includes keys which allow a telephone call to be answered and to be terminated, and which allow for audio output of the telephone call to be via the entertainment audio output device, or via the remote controller audio output.

### DESCRIPTION OF DRAWINGS

In order that this invention may be more easily understood and put into practical effect, reference will now be made to the accompanying drawings which illustrate a preferred embodiment of the invention, wherein:

FIG. 1 is a block diagram illustrating a docking station and mobile phone in accordance with the present invention, and

FIG. 2 is a block diagram illustrating the remote controller of the present invention for use with the docking assembly and mobile phone illustrated in FIG. 1.

### DESCRIPTION OF PREFERRED EMBODIMENT OF INVENTION

Turning now to the preferred embodiment as illustrated in the drawings, in general terms a mobile phone & music player (MPMP) 20 is shown associated with docking assembly 10. The memory system in MPMP 20 can be a semiconductor memory system such as a Flash Memory or a rotating magnetic memory system such as a Hard Drive. The telephone system in MPMP 20 is a mobile phone transceiver capable of connecting and operating with one or more of the mobile phone carrier standards available world wide such as GSM. The music system in MPMP 20 is capable of storing compressed music files in one or more of the standard audio compression formats such as MP3 or AAC and play it back on demand by the user. Being a portable device the music playback is usually through headphones or earbuds.

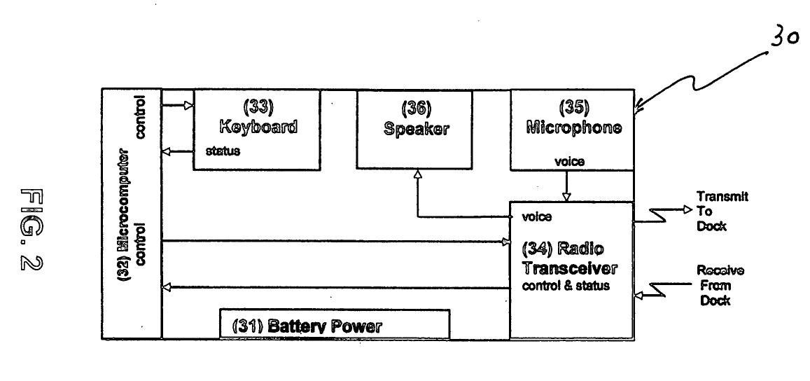

MPMP 20 cooperates with docking assembly 10, and with remote controller 30 as will subsequently be described with reference to FIG. 2, to allow the user to play the music stored on the device through a connected home stereo system whilst effectively operating as a remote telephone allowing the user to answer and receive telephone calls while MPMP 20 is operating in a fixed mode instead of its normal mobile mode.

MPMPs are designed as mobile devices that the user carries on their person. While MPMP 20 may have other functions such as a digital camera or data storage, the primary function of the device is to make and receive telephone calls and to listen to music while away from the home. In the home separate devices handle these two functions. In the majority of homes the telephone is attached to the physical copper wire network which has been installed by telephone companies over the last several decades. To use the home telephone which is connected to the wired network it is necessary to physically go to where the telephone device is attached to the telephone network to make or receive a call. In the majority of homes the music player is part of a Home Stereo system which is relatively large and is located in the Living or Family area which is used for family entertainment. This area is commonly used for Television viewing as well and as such can be viewed as the entertainment hub of the household.

MPMP devices are battery powered and the ability to operate for a reasonable time away from the mains power system gives them portable characteristics. However, when the battery power is consumed they need to have this power replaced. This is done by using re-chargeable batteries in MPMP 20 and providing a connector on the unit to allow it to be connected to a suitable charging circuit to replenish the battery power. In most cases of normal usage, especially when the music player is being used, MPMP batteries have to be re-charged daily because of the higher power requirements over those of a mobile phone only device.

When MPMP 20 is placed in its normal charging device 11 the batteries are charged, however in most cases MPMP 20 cannot be used effectively as a mobile device because it is now tethered to the main power system. When MPMP 20 is placed into dock 10 its batteries are charged in the same way, however by using Remote Controller 30 the most useful functions of MPMP 20 can still be controlled over an extended distance. The mobility of MPMP 20 is effectively replaced by the mobility of Remote Controller 30 so the user does not have to go to MPMP 20 in Dock 10 to control the music player or answer an incoming telephone call.

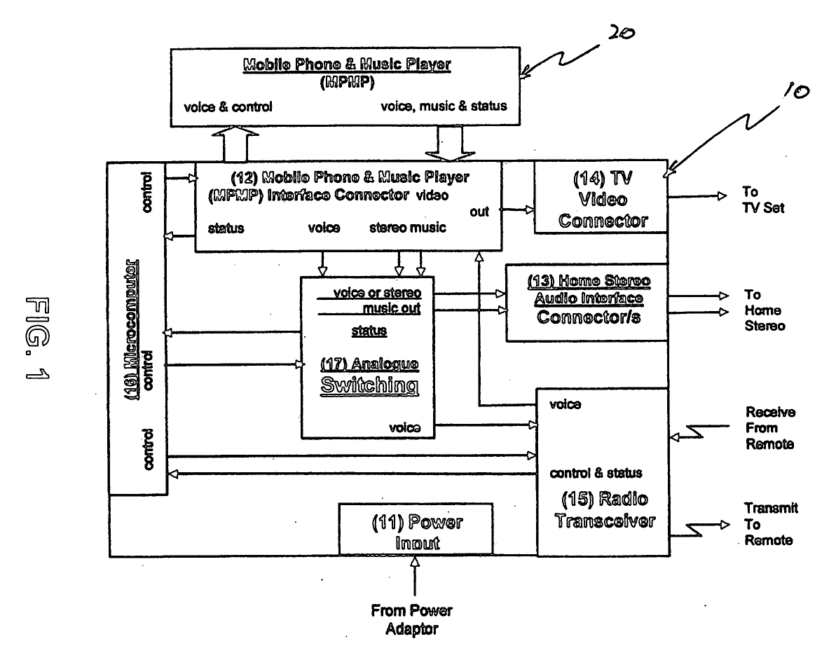

Turning now to FIG. 1, docking assembly 10 consists of number of functional electronic circuits and physical connectors constructed on one or more Printed Circuit Boards (PCB) and housed in an enclosure made of a suitable material such as ABS plastic. Docking assembly 10 has physical wire connections to the external power supply, MPMP 20 and the home stereo system (not shown), and has a wireless connection to Remote Controller 30. Referring to the Block Diagram of docking assembly 10, the functions incorporated in docking assembly 10 are as follows:

Power Input Connector (11)

Docking assembly 10, being a low powered device, is powered from an external Power Adaptor. The Power Adaptor plugs directly into a mains power wall socket, performs the voltage transformation function from the mains power high voltage to the docking assembly low voltage and is transferred to docking assembly 10 via a wire connection to Power Input Connector 11. Other variations of docking assembly 10 may connect directly to the mains power and have the voltage transformation function occur inside docking assembly 10.

MPMP Interface Connector (12)

MPMP Interface Connector 12 is a special connector specified by the mobile phone manufacturer and provides a multiple digital, analogue and power connection between docking assembly 10 and MPMP 20. The mobile phone is connected to docking assembly 10 by the user placing the mobile phone onto MPMP Interface Connector 12. When this is done, docking assembly 10 is able to communicate directly with MPMP 20 and control its functions, transfer information, data, and audio to the phone and receive information, data, and audio from the mobile phone. MPMP Interface Connector 12 also provides power to the mobile phone for it to operate independently of its internal batteries and also allows the mobile phone to charge its internal batteries so the mobile phone can be used as a portable device when required.

Home Stereo Audio Interface Connector/s (13)

The Home Stereo Audio Interface Connector/s 13 connect docking assembly 10 to the Home Stereo System. The connectors can be one of several types commonly used to connect different units of consumer electronics to form functional systems. Commonly the connectors are either a single connector with multiple connections known as a “3.5 mm stereo jack” or two individual connectors each with a signal and earth connection known as “RCA jacks”. The RCA jacks are colour-coded red and white to differentiate each separate stereo audio channel as per the Industry standard. The audio connector in docking assembly 10 has audio performance characteristics required to transfer high quality analogue audio signals to the connecting cable.

TV Video Connector (14)

TV Video Connector 14 connects docking assembly 10 to a standard television set or similar video device which is able to display photo and video images stored on the hard drive of MPMP 20. The connector would normally be an “RCA jack” colour-coded yellow denoting a 75-ohm impedance connection as per the Industry standard.

Radio Transceiver (15)

Radio Transceiver 15 provides a wireless communications link between docking assembly 10 and Remote Controller 30. The radio link could conform to an international standard such as the Bluetooth Specification or it could consist of a proprietary modulation and communications protocol if this has advantages over commercially available wireless systems. Radio Transceiver 15 includes an appropriate aerial and may include station identification, multiple channel capability, data encryption and analogue audio encryption.

Microcomputer (16)

Microcomputer 16 is the control unit of docking assembly 10. It interprets the user's requests sent from Remote Controller 30 and either performs the requests directly or directs MPMP 20 to execute the request conjointly or independently.

Analogue Switching (17)

Analogue Switching function block 17 is included for completeness. It may be required in some implementations of docking assembly 10 depending on the functions available on each specific MPMP. Some MPMPs will have internal Analogue Switching functions which can be controlled by docking assembly 10, while others will need Analogue Switching included in docking assembly 10 to direct the voice and stereo music signals from a selected input to a required output within docking assembly 10.

Turning now to FIG. 2, Remote Controller 30 consists of a number of functional electronic circuits and physical buttons constructed on one or more PCB and housed in an enclosure made of a suitable material such as ABS plastic. Remote Controller 30 is a battery powered stand-alone device used in conjunction with docking assembly 10 but remotely from it. The connection between the Remote Controller and docking assembly 10 is wireless and the communications channel is by a radio link. It is possible that other technologies could be used to make the wireless link such a light transmission, however a radio link is the wireless connection of choice. Referring to the Block Diagram of the Remote Controller, the functions incorporated in the Remote Controller are:

Battery Power Supply (31)

Remoter Controller 30 is powered from its own batteries making it independent from the mains power system. The power supply system may incorporate voltage conversion circuits if multiple voltages are required and a battery charging system if Remote Controller 30 is considered to require rechargeable batteries.

Microcomputer (32)

Microcomputer 32 is the control unit of Remote Controller 30 and interprets the user's requests from Keyboard 33 and sends these requests to docking assembly 10 via radio link 34,15. Microcomputer 32 also performs the switching and control of audio voice signals between Remote Controller 30 and docking assembly 10.

Keyboard (33)

Keyboard 33 allows the user to input the remote functions required to be performed by docking assembly 10, and the local functions required of Remote Controller 30 itself.

Radio Transceiver (34)

Radio Transceiver 34 provides a wireless communications link between Remote Controller 30 and docking assembly 10. The radio link is a two-way communications system and Radio Transceiver 34 in Remote Controller 30 is functionally compatible with Radio Transceiver 15 in docking assembly 10. Radio Transceiver 34 includes an appropriate aerial and may include station identification, multiple channel capability, data encryption and analogue audio encryption.

Microphone (35)

Microphone 35 allows the user to send voice audio to the mobile phone 20 attached to docking assembly 10. The voice audio is sent to docking assembly 10 over the radio link established by Radio Transceivers 34,15.

Speaker (36)

Speaker 36 allows the user to receive voice audio from the mobile phone 20 attached to docking assembly 10. The voice audio is sent from docking assembly 10 over the radio link established by Radio Transceiver 15,34.

Referring to FIGS. 1 and 2 with regard to the external connections of docking assembly 10 and remote controller 30, it will be seen that Power Input Connector 11 is connected to the lead from a Power Adaptor (not shown) which provides operating power for docking assembly 10 and battery charging power for MPMP 20. MPMP Interface Connector 12 is an exposed connector in docking assembly 10 and is the mating part to the connector in the outer casing of MPMP 20. When MPMP 20 is placed in docking assembly 10 the two connector parts mate and provide an electrical connection between docking assembly 10 electronics and MPMP 20 electronics.

Home Stereo Audio Interface Connector/s 13 are connected to the Line Input connector of a Home Stereo System (not shown). The Home Stereo System in the context of the invention is any audio equipment capable of reproducing stereo audio through speakers as opposed to only headphones so that more than one person can hear the audio being played by MPMP 20. Other equipment can include, but is not limited to, such audio devices as Boom Boxes, TV sets, Plasma Screens, Home Theater Systems and similar audio amplification and playback devices.

TV Video Connector 14 is connected to the composite video input (yellow colour-coded RCA jack) of a TV set, Plasma Screen, LCD Display or other compatible viewing device. Radio Transceiver 15 is connected over a wireless (radio) channel to Remote Controller 30 and is able to transmit thereto and receive therefrom data communications and voice communications. Similarly, Radio Transceiver 34 is connected over a wireless (radio) channel to docking assembly 10.

Accordingly it will be seen that the present invention comprises an apparatus for controlling an entertainment system and a communication system, the entertainment system including at least one fixed audio and/or video output device and the communication system including a mobile telephone 20 having storage means for storing audio and/or video data. The apparatus has a docking assembly 10 with phone connector means 12 for establishing wired contact with the mobile telephone, audio and/or video connector means 13,14 for establishing communication with the entertainment system, and a radio transceiver 15 for establishing communication with a remote controller 30. Remote controller 30 has a radio transceiver 34 for establishing communication with the docking assembly 10, an audio input in the form of microphone 35 and an audio output in the form of speaker 36, and input control means in the form of keyboard 33. Microprocessor control means in the form of microprocessors 16,32 are operable in accordance with instructions from the input control means 33 to allow the remote controller 30 to operate as a quasi mobile telephone and to allow the entertainment system to process the audio and/or video data stored in the mobile telephone storage means.

In use, when MPMP 20 is installed in docking assembly 10 via MPMP 20 Interface Connector 12, Microcomputer 16 can communicate with MPMP 20. By the use of a pre-determined set of communications Protocols and Commands Microcomputer 16 can control MPMP 20 independent of the keyboard on MPMP 20. Microcomputer 16 communicates with Remote Controller Microcomputer 32 via Radio Transceiver 15 and the wireless radio link. It is therefore possible for a person using the Remote Controller Keyboard 33 to send one of number a pre-determined MPMP commands (such a Play, Pause, Skip Track etc.) from Remote Controller 30 to docking assembly 10 and have Microcomputer 16 instruct MPMP 20 to execute the command. In this way it is possible for a user to operate an MPMP over a significant distance and while the MPMP is fixed at docking assembly 10, the functionality is mobile by means of the battery powered Remote Controller 30.

Using Remote Controller 30 to operate the Music Player functions of MPMP 20 is equivalent to wireless remote control capability for a hard drive music player.

Without a remote controller, when an MPMP is placed in docking assembly 10 the mobility of the Mobile Phone function of MPMP 20 becomes fixed in the same manner as a the standard wired home phone. If MPMP 20 has an incoming call the user has to go to the location of the phone, take it from docking assembly 10 and answer the call. In effect, the user, by means of taking MPMP 20 from docking assembly 10, converts it from a fixed device back to a mobile device before the incoming phone call could be answered.

However in accordance with the present invention, an incoming phone call can be answered by using Remote Controller 30 which acts as a receiving handset, allows MPMP 20 to remain in docking assembly 10 and allows the user to communicate with the caller.

In addition to the keys on Remote Controller keyboard 33 devoted to the operation of MPMP music player functions, there are other keys used to control MPMP 20 phone function. In a preferred embodiment there are keys called Speakerphone Answer (SPA), Handset Answer (HSA), Handsfree Answer (HFA) and Hang Up (HU), which can be denoted by words or symbols. In more expansive versions, Remote Controller keyboard 33 can have additional keys for other telephone functions.

Thus in use it will be appreciated that the present invention also comprises a method of controlling an entertainment system and a communication system, the entertainment system including at least one fixed audio and/or video output device and the communication system including a mobile telephone 20 having storage means for storing audio and/or video data. The method includes the steps of docking the mobile telephone 20 in phone connector means 12 in a docking assembly 10 to establishing wired contact therebetween; establishing communication between audio and/or video connector means 13,14 in the docking assembly 10 and the entertainment system; establishing communication between respective radio transceivers 15,34 in the docking assembly 10 and in a remote controller 30, and inputting control signals via input control means in the form of keyboard 33 in the remote controller 30 to microprocessor control means in the form of microprocessors 16,32. The microprocessor control means 16,32 are operable in accordance with instructions from the input control means 33 to allow the remote controller 30 to operate as a quasi mobile telephone and to allow the entertainment system to process the audio and/or video data stored in the mobile telephone storage means.

Turning now to various modes of operation, more detailed reference will be made to several options.

Incoming Call Notification

When an incoming call is detected by MPMP 20 it will generate a “ring” sound to alert the user to an incoming call in the normal way. In addition, depending on the embodiment of the invention, docking assembly Microcomputer 16 will receive notification from MPMP 20 of an incoming call. It can mute or pause any music being played from MPMP 20 and cause a “ring” audio signal to be sent to the attached Home Stereo system which would be amplified and broadcast via its speakers. Alternatively it can cause an incoming telephone call message to be sent to Remote Controller 30 via its Radio Transceiver 15 and the wireless radio link. When Remote Controller 30 receives the incoming telephone call message from docking assembly 10 it generates a “ring” audio signal which is amplified and sent to speaker 36 alerting the user that there is an incoming call for MPMP 20.

The user, on receiving the audible notification that there is an incoming telephone call presses either the Speakerphone Answer or Handset Answer Key on the Remote Controller 30.

Incoming Call—Speakerphone Answer

The user presses the Remote Controller Speakerphone Answer key.
The Remote Controller Microcomputer detects the user request and sends a message to docking assembly Microcomputer 16 via the Radio Transceiver 15 and the radio link data communications channel requesting the incoming call be answered in Speakerphone mode.
The Remote Controller Microcomputer activates the Remote Controller Microphone 35 and the Radio Transceiver transmit voice channel connecting Microphone 35 via the radio link to the receive voice channel of docking assembly Radio Transceiver 15.
Docking assembly Microcomputer 16 connects the receive voice channel from the Radio Transceiver 15 to the AudioNoice Input connection of MPMP 20 via MPMP Interface Connector 12.
Docking assembly Microcomputer 16 instructs MPMP 20 via Interface Connector 12 to answer the incoming call.
If MPMP 20 is playing music, the AudioNoice Out signal from MPMP 20 via MPMP Interface Connector 12 is connected to the Home Stereo Audio Interface Connector 13. When the call is answered by MPMP 20 the voice from the remote caller will replace the audio from MPMP 20 music player and be broadcast from the Home Stereo System.
If MPMP 20 is not playing music (idle charge mode), docking assembly Microcomputer 16 will connect the AudioNoice Out signal from MPMP 20 via MPMP Interface Connector 12 to the Home Stereo Audio Interface Connector 13. When the call is answered by MPMP 20 the voice from the remote caller will be broadcast from the Home Stereo System if the Home Stereo System is switched on. If not the user will have to switch it on or remove MPMP 20 from docking assembly 10 to answer the call.
For those MPMPs which need external intervention to change from playing music to answering incoming call voice, docking assembly Microcomputer 16 will send the appropriate commands to MPMP 20 via MPMP Interface Connector 12. For those MPMPs which have separate phone and music player inputs and outputs, Microcomputer 16 activates appropriate analogue switching circuits to make the correct connections. Given that each Docking assembly is for a specific MPMP, such analogue switching circuits would only be present if required by the particular MPMP.

Once the call is answered, a typical Speakerphone configuration is established between Remote Controller 30, docking assembly 10 & MPMP 20 and the Home Stereo System. The voice audio from the remote caller is sent to the Home Stereo System where it is amplified to the same level as the music being played before the call was received. This means that anyone in range of the Home Stereo System able to hear the music from MPMP 20 can also hear the incoming voice audio from the remote caller.

Microphone 35 in Remote Controller 30 is able to receive spoken voice audio in its near vicinity in the same way as any sensitive microphone. This voice audio could be from a number of people within the vicinity of the remote controller. The received voice audio is sent from Remote Controller 30 via Radio Transceiver 34 and the radio link voice channel to docking assembly 10 and into MPMP 20 where the mobile phone circuits send it to the remote caller in the normal way.

The Speakerphone call is full duplex in the normal manner of mobile phone calls and the user can move around and carry Remote Controller 30 with them as needed. Additional functionality can be incorporated into Remote Controller 30 by including Volume Increase and Decrease buttons to command docking assembly microcomputer 16 to raise or lower the volume level being sent to the Home Stereo System. This function will allow the broadcast voice audio volume to be made softer or louder from Remote Controller 30.

Incoming Call—Handset Answer

The operation of Handset Answer is similar to Speakerphone Answer except for the way the voice audio is routed through the system.
The user presses the Handset Answer key.
The Remote Controller Microcomputer 32 detects the user request and sends a message to docking assembly Microcomputer 16 via the Radio Transceiver 34 and the radio link data communications channel requesting the incoming call be answered in Handset mode.
The Remote Controller Microcomputer 32 activates the Remote Controller Microphone 35 and the Radio Transceiver transmit voice channel connecting Microphone 35 via the radio link to the receive voice channel of docking assembly Radio Transceiver 15.
The Remote Controller Microcomputer 32 activates the Remote Controller Speaker 36 and the Radio Transceiver receive voice channel connecting Speaker 36 via the radio link to the transmit voice channel of docking assembly Radio Transceiver 15.
Docking assembly Microcomputer 16 connects the receive voice channel from docking assembly Radio Transceiver 15 to the AudioNoice Input connection of MPMP 20 via MPMP Interface Connector 12.
Docking assembly Microcomputer 16 instructs MPMP 20 via the Interface Connector 12 to answer the incoming call
Docking assembly Microcomputer 16 connects the AudioNoice Output from MPMP 20 to the transmit voice channel of the Radio Transceiver connected to the Remote Controller Speaker 36 via the radio link.
When the call is answered by MPMP 20 the voice from the remote caller will be sent to the Remote Controller Speaker 36 via the radio link and can be heard by the user by placing their ear against the Remote Controller 30 in the region of Speaker 36. Docking assembly Microcomputer 16 also mutes or pauses the music signal being sent to the Home Stereo system to create a low background audio level for the voice conversation.
The Remote Controller Microphone 35 and Speaker 36 are located at opposite ends in the classic mobile phone configuration allowing the user to carry on a phone conversation as if they were using MPMP 20 instead of a remote device connected to MPMP 20 via a radio link.
For those MPMPs which need external intervention to change from playing music to answering an incoming call voice docking assembly Microcomputer 16 will send the appropriate commands to MPMP 20 via MPMP Interface Connector 12. For those MPMPs which have separate phone and music player inputs and outputs the Microcomputer 16 activates appropriate analogue switching circuits to make the correct connections. Given that each Docking assembly 10 is for a specific MPMP, such analogue switching circuits are used only if required by the particular MPMP.

Once the call is answered, a typical telephone handset configuration is established between Remote Controller 30, docking assembly 10 & MPMP 20. The voice audio from the remote caller is sent to Remote Controller 30 where it is amplified to the same level as the handset of a standard telephone system allowing the Remote Controller to be placed to the user's ear for private listening.

Microphone 35 in Remote Controller 30 is adjusted to receive near vicinity spoken voice audio at a suitable level to be transmitted to the remote. The received voice audio is sent from Remote Controller 30 via the Radio Transceiver 34 and the radio link voice channel to docking assembly 10 and into MPMP 20 where the mobile phone circuits send it to the remote caller in the normal way.

The Handset call is full duplex in the normal manner of mobile phone calls and the user can move around and carry Remote Controller 30 with them as needed. Additional functionality can be incorporated into Remote Controller 30 by including Volume Increase and Decrease buttons to command the Remote Controller Microcomputer 32 to raise or lower the volume level being sent to the Remote Controller Speaker 36. This function will allow the received voice audio volume to be made softer or louder for the user.

Incoming Call—Handsfree Answer

The operation of Handsfree Answer is the same as Handset Answer mode except the Remote Controller is used at a distance from the user's head. It can be considered to be a loacalised version of Speakerphone Answer where the telephone conversation is limited to a small distance from the Remote Controller for both speaking to and listening to the remote caller.
The user presses the Handsfree Answer key.
The Remote Controller and Dock answer the incoming call the same way as for Handset Answer.
The Remote Controller Microcomputer adjusts the sensitivity of the Microphone to the same level as is used for Speakerphone Answer.

The Microphone in the Remote Controller is able to receive spoken voice audio in its near vicinity in the same way as any sensitive microphone. This voice audio could be from a number of people within the vicinity of the remote controller. The received voice audio is sent from the Remote Controller via the Radio Transceiver and the radio link voice channel to docking assembly 10 and into MPMP 20 where the mobile phone circuits send it to the remote caller in the normal way.

The audio output level of the Speaker in the Remote Controller can be adjusted by the Volume Control keys so that it is audible in the near vicinity instead of the lower level required when pressed to the user's ear. The voice audio from the remote caller is then audible to a number of people rather than just one person when using Handset Answer.

While Handsfree Answer appears essentially the same as Speakerphone Answer there are a number of significant differences:
Speakerphone Answer requires the Home Stereo system to be powered on and docking assembly 10 to be selected as the input device. Speakerphone Answer is normally used when MPMP 20 is playing music. Handsfree Answer does not use the Home Stereo system and allows the call to be answered locally from the Remote Controller.
Speakerphone Answer allows a large number of people to participate in the phone call. Handsfree Answer only allows people in the near vicinity of the Remote Controller to participate in the phone call and is therefore more private.
In Handsfree mode, audio to the stereo is paused or muted in manner similar to the Handset mode.
   Changing Answer Mode

At any time during a phone call it is possible to change from one Answer Mode to the other by pressing the Answer Key of the new mode required. The sequence of commands and responses when changing from one Answer Mode to another is the same as when an incoming call is being answered.

Hang Up

An active call is terminated by the user with the Hang Up Key whereupon the system returns to the state it was in prior to answering an incoming call. This example uses the Handsfree Answer mode, but the same principle applies to all three Answer modes.
The user presses the Handsfree Answer key.
The Remote Controller Microcomputer 32 detects the user request and sends a message to docking assembly Microcomputer 16 via the Radio Transceiver 34 and the radio link data communications channel requesting the incoming call be terminated.
The Remote Controller Microcomputer 32 disconnects the Remote Controller Microphone 35 from the Radio Transceiver transmit voice channel connecting Microphone 35 via the radio link to the receive voice channel of docking assembly Radio Transceiver 151.
The Remote Controller Microcomputer 32 mutes the Remote Controller Speaker 36.
Docking assembly Microcomputer 16 disconnects the receive voice channel from docking assembly Radio Transceiver 15 to the AudioNoice Input connection of MPMP 20 via MPMP Interface Connector 12.
Docking assembly Microcomputer 16 instructs MPMP 20 via the Interface Connector 12 to terminate the incoming call
Docking assembly Microcomputer 16 disconnects the AudioNoice Output from MPMP 20 to the transmit voice channel of the Radio Transceiver 15 connected to the Remote Controller Speaker 36 via the radio link.
If MPMP 20 is playing music through the Home Stereo system when the call is answered it is resumed when the call is terminated by MPMP 20. The audio from MPMP 20 music player is broadcast from the Home Stereo System.
   Communications Distance

The radio communications distance between Remote Controller 30 and docking assembly 10 is reasonable in a home environment. It is envisaged docking assembly 10 and Remote Controller 30 would be in the same room because commonly an MPMP music player plays the music stored therein through a Home Stereo system. The preferred radio communications system is Bluetooth because it is low cost and will meet the technical requirements in being a full duplex system which supports data and voice transmissions. The original Bluetooth specification has a communication range of 10 meters, which is more than adequate for most applications. Recent revisions of the Bluetooth specification has extended the communications range and consequently greater range is possible if required by the market

The present invention has a number of advantages.

A mobile phone incorporating a hard drive or embedded memory player for music, photos, video and data effectively becomes a complete communications and entertainment system in its own right since it has the capability to store a person's entire music collection. Docking assembly 10 and the remote controller of the present invention allow the mobile phone to be connected to the home stereo system and all functions available with known music only hard drive or embedded memory players are available to music player enhanced mobile phones within the home entertainment system. Installing the MPMP in docking assembly 10 effectively renders the MPMP a fixed phone and while the user can control the music function of docking assembly 10ed phone, the remote controller ensures there is no loss of ability to answer incoming calls due to the phone not being near their person. Making outgoing calls is not such a problem because it is a conscious decision and the person can go to the mobile phone, remove it from docking assembly 10, make the call and replace the mobile phone in docking assembly 10 at which time the playing of music can continue.

It will be appreciated that the present invention allows the user of a docked mobile phone incorporating a hard drive or embedded memory music player to both be able answer an incoming call and control the music playing function using the same remote control unit.

It will of course be realised that whilst the above has been given by way of an illustrative example of this invention, all such and other modifications and variations hereto, as would be apparent to persons skilled in the art, are deemed to fall within the broad scope and ambit of this invention as is herein set forth.

1. Apparatus for controlling an entertainment system and a communication system, the entertainment system including at least one fixed audio and/or video output device and the communication system including a mobile telephone having storage means for storing audio and/or video data, the apparatus including:
a docking assembly including:
phone connector means for establishing wired contact with the mobile telephone,
audio and/or video connector means for establishing communication with the entertainment system, and
a radio transceiver for establishing communication with a remote controller;
a remote controller including:
a radio transceiver for establishing communication with the docking assembly,
an audio input and an audio output, and
input control means; and
microprocessor control means operable in accordance with instructions from the input control means to allow the remote controller to operate as a quasi mobile telephone and to allow the entertainment system to process the audio and/or video data stored in the mobile telephone storage means.

2. Apparatus for controlling an entertainment system and a communication system as claimed in claim 1, wherein the docking assembly includes battery charging means for recharging a mobile phone battery.

3. Apparatus for controlling an entertainment system and a communication system as claimed in claim 1, wherein the docking assembly and the remote controller each includes microprocessor control means.

4. Apparatus for controlling an entertainment system and a communication system as claimed in claim 1, wherein the audio and/or video connector means establish wired communication with the entertainment system.

5. Apparatus for controlling an entertainment system and a communication system as claimed in claim 1, wherein the audio and/or video connector means establish wireless communication with the entertainment system.

6. Apparatus for controlling an entertainment system and a communication system as claimed in claim 1, wherein the input control means is a keyboard or keypad.

7. Apparatus for controlling an entertainment system and a communication system as claimed in claim 6, wherein the keyboard or keypad includes keys which allow a telephone call to be answered and to be terminated, and which allow for audio output of the telephone call to be via the entertainment audio output device, or via the remote controller audio output.

8. A method of controlling an entertainment system and a communication system, the entertainment system including at least one fixed audio and/or video output device and the communication system including a mobile telephone having storage means for storing audio and/or video data, the method including:
docking the mobile telephone in phone connector means in a docking assembly to establishing wired contact therebetween;
establishing communication between audio and/or video connector means in the docking assembly and the entertainment system;
establishing communication between respective radio transceivers in the docking assembly and in a remote controller, and
inputting control signals via input control means in the remote controller to microprocessor control means;
the microprocessor control means being operable in accordance with instructions from the input control means to allow the remote controller to operate as a quasi mobile telephone and to allow the entertainment system to process the audio and/or video data stored in the mobile telephone storage means.

9. A method of controlling an entertainment system and a communication system substantially as described with reference to the embodiments illustrated in the drawings.

10. Apparatus for controlling an entertainment system and a communication system substantially as described with reference to the embodiments illustrated in the drawings.
